(19) United States
(12) Patent Application Publication
(10) Pub. No.: US 2026/0120239 A1
(43) Pub. Date: Apr. 30, 2026

(54) DEVICE AND METHOD FOR GENERATING SUPER-RESOLUTION IMAGES THROUGH PIXEL LEVEL CLASSIFICATION

(71) Applicant: UIF (UNIVERSITY INDUSTRY FOUNDATION), YONSEI UNIVERSITY, Seoul (KR)

(72) Inventors: Seon Joo Kim, Seoul (KR); Jinho Jeong, Seoul (KR); Jinwoo Kim, Seoul (KR)

(73) Assignee: UIF (UNIVERSITY INDUSTRY FOUNDATION), YONSEI UNIVERSITY, Seoul (KR)

(21) Appl. No.: 18/934,175

(22) Filed: Oct. 31, 2024

(30) Foreign Application Priority Data
Oct. 28, 2024 (KR) 10-2024-0149028

(51) Int. Cl. G06T 3/4053; G06T 3/4046; G06T 5/60; G06T 7/00; G06V 10/764

(52) U.S. Cl. CPC G06T 3/4053; G06T 3/4046; G06T 5/60; G06T 7/0002; G06V 10/764; G06T 2207/20081; G06T 2207/20084

(57) ABSTRACT

The present disclosure relates to a device and a method for generating super-resolution images through pixel level classification, wherein the device comprises an image input unit receiving a low-resolution image; a backbone network unit providing the low-resolution image to a backbone network as input data to generate a low-resolution feature map as output data; a pixel classifier receiving the low-resolution feature map and coordinates of a specific pixel and determining an upsampler responsible for reconstruction by predicting reconstruction difficulty of the specific pixel; an upsampling unit including a plurality of upsamplers constructed based on the reconstruction difficulty and performing a pixel level operation which upsamples the specific pixel through the determined upsampler responsible for the reconstruction among the plurality of upsamplers; and a super-resolution image output unit generating a super-resolution image by outputting the upsampled specific pixel at the coordinates of the specific pixel of the low-resolution image.

### CROSS-REFERENCE TO RELATED APPLICATION

This application claims under 35 U.S.C. § 119(a) the benefit of Korean Patent Application No. 10-2024-0149028 filed on Oct. 28, 2024, the entire contents of which is incorporated herein by reference.

### TECHNICAL FIELD

The present disclosure relates to a technology for generating super-resolution images and, more specifically, to a device and a method for generating super-resolution images through pixel level classification, which may improve the efficiency of generating super-resolution images by adaptively allocating computational resources at the pixel level.

### BACKGROUND

Single image super-resolution (SISR) refers to a task that aims to reconstruct a high-resolution (HR) image from a low-resolution (LR) image. This task is widely used in various fields such as digital photography, medical imaging, surveillance, and security. In particular, single image super-resolution (SISR) has evolved together with the development of deep neural networks (DNNs).

However, with the emergence of new single image super-resolution (SISR) models, the model capacity and computational cost have risen, making it difficult to deploy the SISR to resource-constrained applications or devices. Accordingly, there has been a shift toward designing simple and efficient lightweight models that seeks a balance between performance and computational cost. Also, research is being conducted to reduce the number of parameters or floating point operations (FLOPs) in existing models without sacrificing the performance.

Meanwhile, as platforms such as smartphones, high-definition TVs, and monitors supporting 2K to 8K resolutions provide users with large-scale images, the demand for efficient super-resolution (SR) is increasing steadily. Large-scale images may not be processed in a single process, i.e., the entire image may not be handled at once due to limitations in computational resources. Therefore, super-resolution (SR) for large-scale images uses a per-patch processing method that partitions a given low-resolution (LR) image into patches, independently applies an SR model to each patch, and then merges the results to obtain a high-resolution image.

Recently, efficiency has been improved by partitioning a low-resolution image into patches according to reconstruction difficulty and allocating computational resources appropriately to each patch. However, if the reconstruction difficulty varies across pixels, uniform allocation of computational resources within a patch may actually decrease efficiency.

### PRIOR ART REFERENCES

### Patent Document

Korean registered patent No. 10-2534657 (May 16, 2023)

### DESCRIPTION

### Problem to be Solved

One embodiment of the present disclosure provides a device and a method for generating super-resolution images through pixel level classification, which may improve the efficiency of generating super-resolution images by adaptively allocating computational resources at the pixel level.

One embodiment of the present disclosure provides a device and a method for generating super-resolution images through pixel level classification, which may optimize the use of computational resources by allocating an appropriate upsampler according to the reconstruction difficulty of each pixel and balance performance and computational cost in the inference process without retraining.

### Solution

Among embodiments, a device for generating super-resolution images through pixel level classification comprises an image input unit receiving a low-resolution image; a backbone network unit providing the low-resolution image to a backbone network as input data to generate a low-resolution feature map as output data; a pixel classifier receiving the low-resolution feature map and coordinates of a specific pixel and determining an upsampler responsible for reconstruction by predicting reconstruction difficulty of the specific pixel; an upsampling unit including a plurality of upsamplers constructed based on the reconstruction difficulty and performing a pixel level operation which upsamples the specific pixel through the determined upsampler responsible for the reconstruction among the plurality of upsamplers; and a super-resolution image output unit generating a super-resolution image by outputting the upsampled specific pixel at the coordinates of the specific pixel of the low-resolution image.

The backbone network unit may select the Fast Super-Resolution Convolutional Neural Network (FSRCNN), the Cascading Residual Network (CARN), or the Super-Resolution Residual Network (SRResNet) as the backbone network based on reconstruction characteristics of the low-resolution image.

The pixel classifier may determine one of reconstruction difficulty levels assigned for processing to the plurality of upsamplers based on the low-resolution feature map as the reconstruction difficulty of the specific pixel.

The pixel classifier may determine an upsampler with a relatively large capacity if the specific pixel is composed of a relatively complex pattern or texture.

The pixel classifier may determine an upsampler with a relatively small capacity if the specific pixel is composed of a relatively simple pattern.

The upsampling unit may determine the reconstruction difficulty level based on the low-resolution feature map and determine the number of the plurality of upsamplers.

The upsampling unit may implement the plurality of upsamplers to perform different upsampling techniques according to the reconstruction difficulty level.

The super-resolution image output unit may perform pixel-wise refinement on the super-resolution image to post-process artifact pixels if discontinuity occurs between adjacent pixels reconstructed through the plurality of upsamplers.

The super-resolution image output unit may determine the discontinuity by applying Peak Signal-to-Noise Ratio (PSNR), Structural Similarity Index (SSIM), or Floating Point Operations (FLOPs) to the super-resolution image.

Among embodiments, in a method for generating super-resolution images through pixel level classification performed by a device for generating super-resolution images through pixel level classification, a method for generating super-resolution images through pixel level classification comprises receiving a low-resolution image; providing the low-resolution image to a backbone network as input data to generate a low-resolution feature map as output data; receiving the low-resolution feature map and coordinates of a specific pixel and determining an upsampler responsible for reconstruction by predicting reconstruction difficulty of the specific pixel; including a plurality of upsamplers constructed based on the reconstruction difficulty and performing a pixel level operation which upsamples the specific pixel through the determined upsampler responsible for the reconstruction among the plurality of upsamplers; and generating a super-resolution image by outputting the upsampled specific pixel at the coordinates of the specific pixel of the low-resolution image.

### Effect

The present disclosure may provide the following effects. However, since it is not meant that a specific embodiment has to provide all of or only the following effects, the technical scope of the present disclosure should not be regarded as being limited by the specific embodiment.

A device and a method for generating super-resolution images through pixel level classification according to the present disclosure may improve the efficiency of generating super-resolution images by adaptively allocating computational resources at the pixel level.

A device and a method for generating super-resolution images through pixel level classification according to the present disclosure may optimize the use of computational resources by allocating an appropriate upsampler according to the reconstruction difficulty of each pixel and balance performance and computational cost in the inference process without retraining.

### BRIEF DESCRIPTION OF THE DRAWINGS

FIG. 1 illustrates a device for generating super-resolution images through pixel level classification according to the present disclosure.

FIG. 2 is a flow diagram illustrating a method for generating super-resolution images through pixel level classification according to the present disclosure.

FIGS. 3 to 6 illustrate experimental results according to the present disclosure.

FIG. 7 illustrates the system structure of a device for generating super-resolution images according to the present disclosure.

FIG. 8 illustrates a system for generating super-resolution images according to the present disclosure.

### DETAILED DESCRIPTION

Specific structural or functional descriptions in the embodiments of the present disclosure introduced in this specification or application are only for description of the embodiments of the present disclosure. The descriptions should not be construed as being limited to the embodiments described in the specification or application. The present disclosure may, however, be embodied in many different forms, but should be construed as covering modifications, equivalents or alternatives falling within ideas and technical scopes of the present disclosure. Further, since effects disclosed herein do not mean that a specific embodiment should include all or only the effects, the scope of the present disclosure should not be construed as being limited thereto.

Meanwhile, the meaning of terms described herein will be understood as follows.

It will be understood that, although the terms “first”, “second”, etc. may be used herein to distinguish one element from another element, these elements should not be limited by these terms. For instance, a first element discussed below could be termed a second element without departing from the teachings of the present disclosure. Similarly, the second element could also be termed the first element.

It will be understood that when an element is referred to as being “coupled” or “connected” to another element, it can be directly coupled or connected to the other element or intervening elements may be present therebetween. In contrast, it should be understood that when an element is referred to as being “directly coupled” or “directly connected” to another element, there are no intervening elements present. Other expressions that explain the relationship between elements, such as “between”, “directly between”, “adjacent to” or “directly adjacent to” should be construed in the same way.

In the present disclosure, the singular forms are intended to include the plural forms as well, unless the context clearly indicates otherwise. It will be further understood that the terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

In each step, reference characters (e.g. a, b, c, etc.) are used for the convenience of description. The reference characters do not designate the order of the steps, and the steps may be performed in a different order unless the context clearly indicates otherwise. That is, the steps may be performed in the specified order, may be performed substantially simultaneously, or may be performed in a reverse order.

The present disclosure can be implemented as a computer-readable code on a computer-readable recording medium. The computer-readable recording medium includes all types of recording devices in which data readable by a computer system is stored. Examples of the computer-readable recording medium include ROM, RAM, CD-ROM, magnetic tape, floppy disk, an optical data storage device, etc. In addition, the computer-readable recording medium may be distributed in a computer system connected via a network, so that computer-readable codes may be stored and executed in a distributed manner.

Unless otherwise defined, all terms including technical and scientific terms used herein have the same meaning as commonly understood by one of ordinary skill in the art to which the present disclosure belongs. It will be further understood that terms used herein should be interpreted as having a meaning that is consistent with their meaning in the context of this specification and the relevant art and will not be interpreted in an idealized or overly formal sense unless expressly so defined herein.

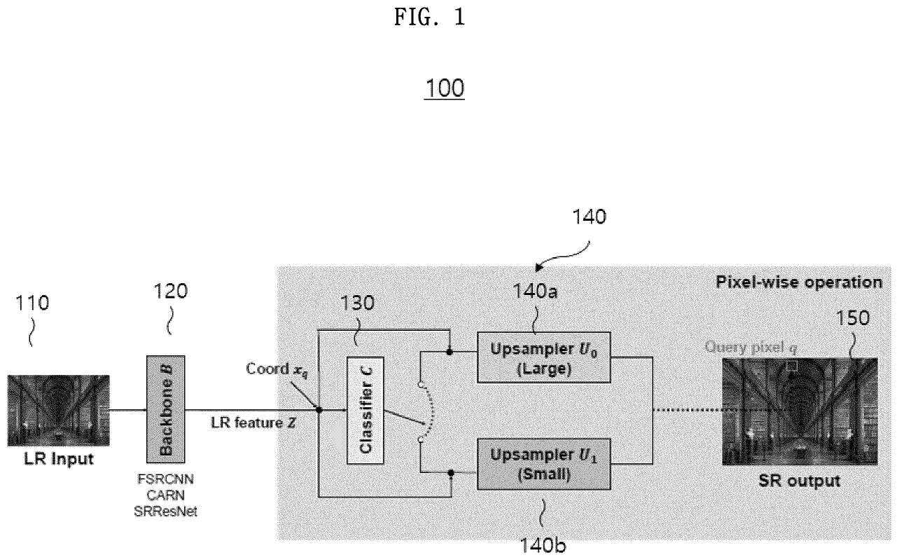

FIG. 1 illustrates a device for generating super-resolution images through pixel level classification according to the present disclosure.

Referring to FIG. 1, the device for generating super-resolution images 100 may generate super-resolution images by adaptively allocating computational resources through pixel level classification and, to this end, may include an image input unit 110, a backbone network unit 120, a pixel classifier 130, an upsampling unit 140, and a super-resolution image output unit 150.

The image input unit 110 may receive a low-resolution image. The image input unit 110 may feed-forward the low-resolution image to the backbone network unit 120 to extract low-resolution features of the input image.

The backbone network unit 120 may input the low-resolution image as input data to the backbone network and generate a low-resolution feature map as output data. In one embodiment, the backbone network unit 120 may select the Fast Super-Resolution Convolutional Neural Network (FSRCNN), the Cascading Residual Network (CARN), or the Super-Resolution Residual Network (SRResNet) as the backbone network based on reconstruction characteristics of the low-resolution image; however, the present disclosure is not limited to the specific example and may select various deep learning-based SR network models. For example, for real-time applications, a lightweight backbone network such as the FSRCNN or CARN may be suitable, while a sophisticated backbone network such as the SRResNet may be preferred when high-quality image reconstruction is critical.

The backbone may learn and extract important features of an image based on various neural network structures.

The backbone network unit 120 may input a low-resolution image into a selected backbone network and generate a high-dimensional low-resolution feature map through a multi-layer neural network. Here, the feature map may include key information such as detailed patterns, boundaries, and textures of the image.

The pixel classifier 130 may receive a low-resolution feature map and the coordinates of a specific pixel, predict the reconstruction difficulty of the specific pixel, and determine an upsampler responsible for reconstruction. The pixel classifier 130 may assign one of the upsamplers according to the classification probability to predict the RGB value of given query pixel coordinates x_{q} based on a multi-layer perceptron (MLP). Here, the pixel coordinates x_{q} correspond to the position information of each pixel to be reconstructed. In one embodiment, the pixel classifier 130 may determine one of the reconstruction difficulty levels assigned to a plurality of upsamplers based on the low-resolution feature map as the restoration difficulty of the specific pixel. Some pixels may require substantial computational resources and complex operations for reconstruction, while other pixels may be reconstructed more easily with fewer resources. The pixel classifier 130 may predict the reconstruction difficulty of each pixel based on the input low-resolution feature map Z and pixel coordinates x_{q} and may allocate an appropriate upsampler according to the predicted reconstruction difficulty. Through the operation above, computational resources may be saved while minimizing performance degradation by optimizing resources on a pixel-by-pixel basis.

In one embodiment, the pixel classifier 130 may determine a upsampling unit 140a with a relatively large capacity when a specific pixel contains a relatively complex pattern or texture. The pixel classifier 130 may determine a upsampling unit 140b with a relatively small capacity when a specific pixel contains a relatively simple pattern.

Assuming that the low-resolution (LR) input is X∈ [symbol] , the high-resolution (HR) input is Y∈ [symbol] , pixel coordinates in the high-resolution (HR) image are { [symbol] }_{i=1 . . . HW}, and the RGB value is {Y( [symbol] )}_{i=1 . . . HW}, the low-resolution feature map Z∈ [symbol] may be calculated using the backbone network from the low-resolution image. Here, h and w represent the height and width of the low-resolution image, H and W represent the height and width of the high-resolution image, and D represents the number of channels of the feature map. Then, the pixel classifier 130 may obtain the classification probability pᵢ∈ [symbol] for each pixel when the number of classes M is given, which may be defined by Eq. 1 below.

$${p}_{i} = σ ( C ( Z , {i}_{} ; {θ}_{C} ) ) \qquad [ Eq . 1 ]$$

Here, σ is the softmax function.

The upsampling unit 140 may include a plurality of upsamplers 140a, 140b built based on the reconstruction difficulty and may perform a pixel level operation to upsample a specific pixel through an upsampler responsible for reconstruction determined among the plurality of upsamplers 140a, 140b. In one embodiment, the upsampling unit 140 may determine the number of the plurality of upsamplers by determining the reconstruction difficulty level based on the low-resolution feature map. The upsampling unit 140 may implement the plurality of upsamplers 140a, 140b to perform different upsampling techniques according to the reconstruction difficulty level. The upsampling techniques may include sub-pixel convolution, deconvolution (transpose convolution), bilinear or bicubic interpolation, and Local Implicit Image Function (LIIF).

Sub-pixel convolution is a method that may convert a low-resolution image to a high-resolution image in a single step and is efficient for producing high-resolution output from the output channel of a CNN. Deconvolution (transpose convolution) is a method for increasing the image resolution by applying the convolution filter in reverse, which may require a substantial number of computations but, if effectively trained, may provide accurate upsampling results. Bilinear or bicubic interpolation is a method that increases the image resolution by predicting the intermediate values based on given pixel values, which has limitations in reconstructing complex patterns. Local Implicit Image Function (LIIF) is a method that predicts the value of each pixel in a high resolution image based on the coordinates of each pixel in a low-resolution image; it may efficiently generate a high-resolution image by predicting the reconstruction difficulty for each pixel and selecting an upsampler suitable for the predicted reconstruction difficulty. The upsampling unit 140 may predict the RGB value of each pixel based on the information extracted from the low-resolution feature map, and during the process above, pixels requiring complex operations may be processed through the large-capacity upsampling unit 140a, and pixels requiring simple operations may be processed through the relatively small-capacity upsampling unit 140b. The operation above may reduce the waste of computational resources.

In one embodiment, the plurality of upsamplers 140a, 140b may perform the LIFE technique, which is suitable for pixel-level processing among upsampling techniques. In other words, when processing each pixel using the LIFE upsampling technique, the pixel coordinates [symbol] of the high-resolution (HR) image is normalized and converted to the coordinates [symbol] ∈ [symbol] of the low-resolution (LR) space, and then the feature and coordinates closest to the corresponding coordinates (based on the Euclidean distance) may be obtained. At this time, in the given low-resolution feature map Z, zᵢ*∈ [symbol] represents the feature closest to [symbol] , and vᵢ*∈ [symbol] means the coordinates corresponding to the feature. The upsampling process may be defined by Eq. 2 below.

$${I}^{SR} ( {i}_{} ) = U ( Z , {i}_{} ; {θ}_{U} ) = U ( [ {z}_{i}^{*} , {{\hat{}}^{}}_{i} - {v}_{i}^{*} ] ; {θ}_{U} ) \qquad [ Eq . 2 ]$$

Here, I^{SR}( [symbol] )∈ [symbol] represents the RGB value at [symbol] , and [·] represents the concatenation operation.

The upsampling unit 140 may use M parallel upsamplers {U₀, U₁, . . . , U_{M-1}} with different processing capacities to handle different levels of reconstruction difficulty.

The super-resolution image output unit 150 may generate a super-resolution image by outputting an upsampled specific pixel to the coordinates of the specific pixel of a low-resolution image. When adjacent pixels are reconstructed through different upsamplers, discontinuity may occur between them. When discontinuity occurs between adjacent pixels reconstructed through a plurality of upsamplers 140a, 140b, the super-resolution image output unit 150 may perform pixel-wise refinement on the super-resolution image to post-process artifact pixels. Pixel-wise refinement is a method of replacing the RGB value of a specific pixel with the average value of adjacent pixels. The super-resolution image output unit 150 may determine the presence of discontinuity by applying Peak Signal-to-Noise Ratio (PSNR), Structural Similarity Index (SSI) or Floating Point Operations (FLOPs) to the super-resolution image.

The device 100 for generating super-resolution images may improve the efficiency of the single image super-resolution (SISR) task by predicting the reconstruction difficulty of each pixel through the backbone network unit 120, pixel classifier 130, and upsampling unit 140; the device 100 optimizes resource utilization by allocating an appropriate upsampler based on the reconstruction difficulty.

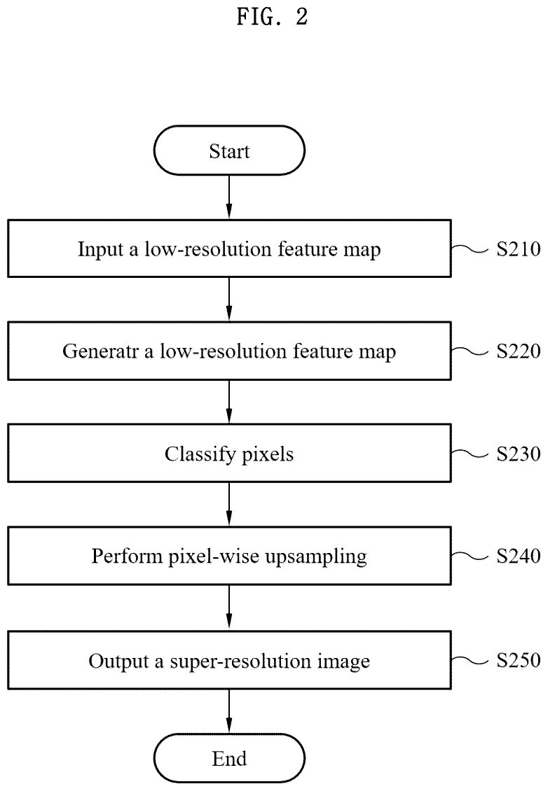

FIG. 2 is a flow diagram illustrating a method for generating super-resolution images through pixel level classification according to the present disclosure.

Referring to FIG. 2, the device 100 for generating super-resolution images may receive a low-resolution image through the image input unit 110 S210. The device 100 for generating super-resolution images may input the low-resolution image as input data to the backbone network through the backbone network unit 120 and generate a low-resolution feature map as output data S220.

Also, the device 100 for generating super-resolution images may receive a low-resolution feature map and the coordinates of a specific pixel through the pixel classifier 130 and predict the reconstruction difficulty of the specific pixel to determine an upsampler responsible for the reconstruction S230. The device 100 for generating super-resolution images may include a plurality of upsamplers 140a, 140b built based on the reconstruction difficulty through the upsampling unit 140 and perform a pixel-wise operation to upsample the specific pixel through an upsampler responsible for the reconstruction determined among the plurality of upsamplers 140a, 140b S240.

Also, the device 100 for generating super-resolution images may generate a super-resolution image by outputting an upsampled specific pixel to the coordinates of the specific pixel of the low-resolution image through the super-resolution image output unit 150 S250. The super-resolution image output unit 150 may perform post-processing of artifact pixels by performing pixel-wise refinement on the super-resolution image when discontinuity occurs between adjacent pixels reconstructed through the plurality of upsamplers 140a, 140b.

A method for generating super-resolution images through pixel level classification according to the present disclosure proposes a pixel-level classifier for single image super-resolution (PCSR) model capable of optimizing the use of computational resources by adaptively allocating the computational resources at the pixel level.

The PCSR model proposed in the present disclosure may be implemented by including a backbone network, a pixel-level classifier, and pixel-level upsamplers with various capacities. The backbone network may input a low-resolution image and generate a low-resolution feature map. For each pixel in the high-resolution space, the pixel-level classifier may predict the probability of assigning the corresponding pixel to a specific upsampler using the low-resolution feature map and the relative position of the corresponding pixel. Accordingly, each pixel may be adaptively assigned to a pixel-level upsampler with an appropriate capacity to predict the RGB value of the pixel. Finally, the RGB value of each pixel may be combined to obtain a super-resolution output.

The PCSR model proposed in the present disclosure may balance the performance and computational cost during the inference stage without requiring retraining. Also, the K-means clustering algorithm may be used to assign pixels, simplifying the user experience.

In the learning phase, each pixel may be input to all upsamplers, and the results from the upsamplers may be combined to perform a process of backpropagating the gradient as described by Eq. 3 below.

$$\hat{Y} ( {y}_{i} ) = {\sum }_{j = 0}^{M - 1} {p}_{i , j} \times {U}_{j} ( Z , {y}_{i} ; {θ}_{{U}_{j}} ) \qquad [ Eq . 3 ]$$

In Eq. 3, Ŷ( [symbol] )∈ [symbol] represents the RGB output at the pixel [symbol] , and p_{i,j} represents the probability that the corresponding query pixel belongs to the upsampler Uⱼ.

Then, learning may be conducted through two loss functions, reconstruction loss L_{recon} and average loss L_{avg}. The average loss is similar to that used in the conventional super-resolution (SR). The reconstruction loss may be defined as the loss LI between the RGB value of a predicted output and the target value. Here, the target value may be regarded as the difference between a reference high-resolution (HR) patch and a bilinearly interpolated low-resolution (LR) input patch, to allow the classifier to operate effectively even with minimal capacity, especially, to train the classifier to extract high-frequency features accurately. The reconstruction loss may be expressed by Eq. 4 below.

$${L}_{recon} = {\sum }_{i = 1}^{HW} \vert ( Y ( {y}_{i} ) - upX ( {y}_{i} ) ) - {Y}^{'} ( {y}_{i} ) \vert \qquad [ Eq . 4 ]$$

Here, upX( [symbol] ) represents the RGB value at position [symbol] of a bilinearly upsampled low-resolution (LR) input patch.

The average loss may be defined by Eq. 5 to assign pixels to the respective classes uniformly.

$${L}_{avg} = {\sum }_{j = 1}^{M} \vert {\sum }_{n = 1}^{N} {\sum }_{i = 1}^{HW} {p}_{n , i , j} - \frac{NHW}{M} \vert \qquad [ Eq . 5 ]$$

Here, p_{n,i,j} represents the probability that the i-th pixel of the n-th high-resolution (HR) image (where N is the batch size) belongs to the j-th class. The target is set to

$$\frac{NHW}{M}$$

to assign the same number of pixels to each class (or upsampler) from the total NHW pixels.

Since simultaneously training the backbone (B), classifier (C), and upsampler (U_{j∈[0,M]}) that constitute the present disclosure from the beginning may result in unstable learning, multi-step training may be performed. Assuming that the capacity of the upsampler decreases from U₀ to U_{M-1}, the upper limit of the model performance is determined by the backbone (B) and the upsampler U₀ with the largest capacity. Therefore, initially, {B, U₀} is trained using only the reconstruction loss, and then the process of i) freezing the already learned {B, U₀, . . . , Uⱼ₋₁} from j=1 to j=M−1, ii) connecting Uⱼ to the backbone (newly connecting C when j=1), and iii) jointly training {Uⱼ, C} using the total loss may be performed repeatedly.

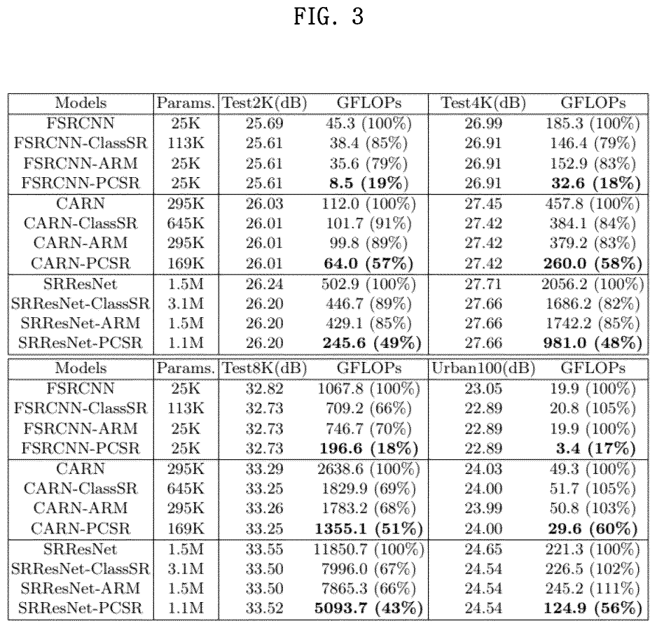

In what follows, experimental results related to the method for generating super-resolution images through pixel level classification according to the present disclosure will be described in detail with reference to FIGS. 3 to 6.

Here, the overall training settings are adjusted to align with those of ClassSR and ARM for fair comparison. DIV2K (index 0001-0800) is cropped densely into 1.59 million 32×32 low-resolution (LR) sub-images to create a training dataset, and random rotation and flipping are applied for data augmentation. FSRCNN, CARN, and SRResNet are used as backbones, and the original parameters are set to 25K, 295K, and 1.5M, respectively. The batch size is 16 in the training phase for the original model and the proposed PCSR model; the initial learning rate is set to 0.001 for FSRCNN and 0.0002 for CARN and SRResNet using cosine annealing scheduling.

Performance is evaluated on Test2K/Test4K/Test8K downsampled from DIV8K and Urban100, which consists of much larger images than commonly used benchmarks such as Set5 and Set14. For the case of evaluation index, the quality of super-resolution (SR) images is evaluated using Peak Signal-to-Noise Ratio (PSNR), and the computational efficiency is measured using Floating Point Operations (FLOP). PSNR is calculated in the RGB space, and FLOP is measured across the entire image.

Referring to FIG. 3, the computational efficiency of PCSR, the method proposed in the present disclosure, is clearly demonstrated. Here, the existing patch level classification method and the PCSR method of the present disclosure are compared on large-scale image super-resolution benchmarks such as Test2K, Test4K, Test8K, and Urban 100 (×4 SR).

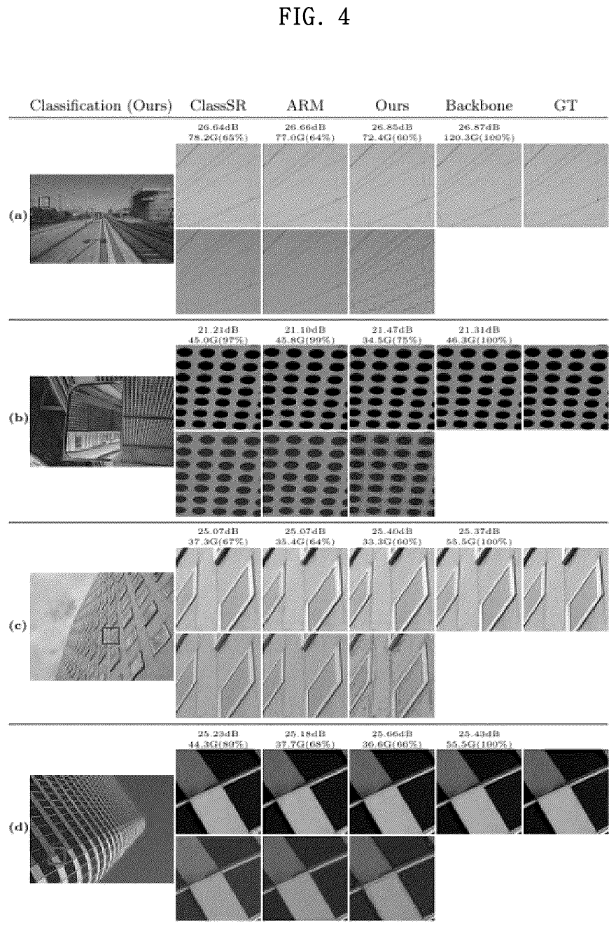

Also, FIG. 4 shows the qualitative results including PSNR and FLOPs for each generated image. While the existing patch-based methods such as ClassSR and ARM fail to classify the reconstruction difficulty at finer levels, the method according to the present disclosure (PCSR) may process the input image more accurately through pixel-level classification, thereby generating super-resolution output in an efficient and effective manner. In (a) of FIG. 4, ClassSR and ARM classifies a patch area dominated by flat areas as easy and fails to reconstruct thin lines faithfully; however, the method according to the present disclosure properly classifies and reconstructs the thin lines through pixel-level difficulty classification. In (b) of FIG. 4, existing patch-based methods involve excessive computations, while the method according to the present disclosure exhibits significant computational savings. This means that the method according to the present disclosure efficiently distributes computational resources. (c) of FIG. 4 shows that ClassSR wastes computational resources and ARM reduces computations excessively, resulting in lower output quality, while the method according to the present disclosure improves performance by utilizing resources more effectively.

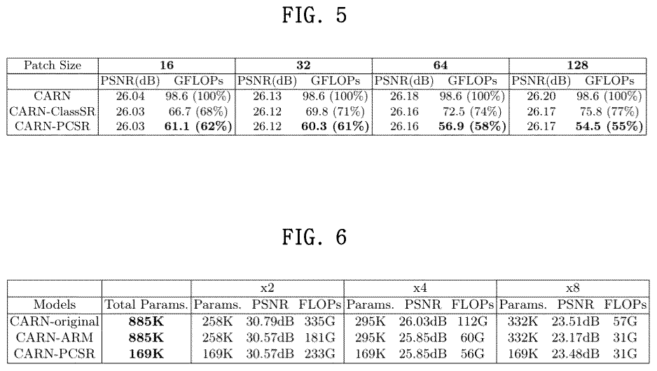

FIG. 5 shows a result of comparing the method according to the present disclosure (PCSR) and the ClassSR method according to the patch size in Test2K (×4). As shown in FIG. 5, the efficiency of the existing patch-based method decreases as the patch size increases. It is as the patch size increases, it becomes more likely that easy and difficult areas are mixed at the pixel level, making it difficult to accurately predict the patch difficulty. In contrast, the method according to the present disclosure demonstrates its capability to process patches of all sizes without sacrificing computational efficiency by employing the pixel-level approach. In other words, the method according to the present disclosure is more efficient than the patch-level approach for all patch sizes, and the advantage becomes more evident as patch size increases.

When LIIF is utilized as an upsampler, the method according to the present disclosure may leverage of the multi-scale super-resolution (SR) feature of LIIF. Referring to FIG. 6, the method according to the present disclosure shows the advantage of being able to extend the original resolution to arbitrary scale super-resolution, including non-integer scales, which may not be achieved with the existing patch-based approaches.

Experimental results show that the method (PCSR) according to the present disclosure outperforms the existing methods in terms of the balance between PSNR and FLOP in various single image super-resolution (SISR) models and benchmark tests.

As a result, the method of generating super-resolution images through pixel-level classification according to the present disclosure is an efficient, new approach for generating large-scale super-resolution images, which may address the issue of varying reconstruction difficulties by allocating computational resources at the pixel level and reduce redundant computations at finer levels. Also, the method may balance performance and computational cost without requiring retraining and additionally provide automatic pixel assignment using K-means clustering and post-processing to remove artifacts.

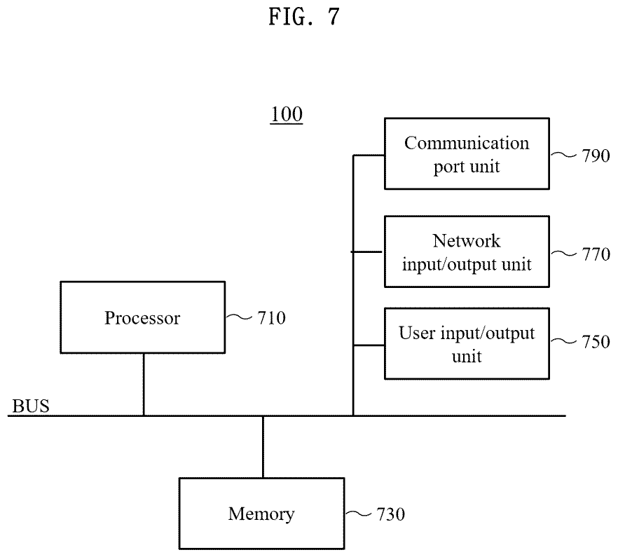

FIG. 7 illustrates the system structure of a device for generating super-resolution images according to the present disclosure.

Referring to FIG. 7, the device for generating super-resolution images 100 may include a processor 7, a memory 730, a user input/output unit 750, a network input/output unit 770, and a communication port unit 790.

The processor 710 may execute a super-resolution image generation procedure through pixel level classification according to an embodiment of the present disclosure, manage a memory 730 that is read or written in this process, and schedule a synchronization time between a volatile memory and a non-volatile memory in the memory 730. The processor 710 may control the overall operation of the device 100 for generating super-resolution images and may be electrically connected to the memory 730, the user input/output unit 750, the network input/output unit 770, and the communication port unit 790 to control the data flow among them. The processor 710 may be implemented as a Central Processing Unit (CPU) of the device 100 for generating super-resolution images.

The memory 730 may include an auxiliary memory device, implemented as a non-volatile memory such as a Solid State Disk (SSD) or a Hard Disk Drive (HDD) and used to store all data required for the device 100 for generating super-resolution images, and a main memory device implemented as a volatile memory such as a Random Access Memory (RAM). Also, the memory 730 may store a set of commands that, when executed by the electrically connected processor 710, execute a method for generating super-resolution images through pixel level classification according to the present disclosure.

The user input/output unit 750 includes an environment for receiving user input and an environment for outputting specific information to the user, which may include, for example, an input device including an adapter such as a touch pad, a touch screen, a virtual keyboard, or a pointing device and an output device including an adapter such as a monitor or a touch screen. In one embodiment, the user input/output unit 750 may correspond to a computing device connected via remote access, and in such a case, the device 100 for generating super-resolution images may be operated as an independent server.

The network input/output unit 770 provides a communication environment for connecting to the user terminal 810 via a network, which may include, for example, an adapter for communication such as a Local Area Network (LAN), a Metropolitan Area Network (MAN), a Wide Area Network (WAN), and a Value Added Network (VAN). Also, the network input/output unit 770 may be implemented to provide a short-range communication function such as WiFi or Bluetooth or a wireless communication function of 4G or higher for wireless transmission of data.

The communication port unit 790 is a hardware interface for connecting to external hardware; for example, the external hardware may include a printer, a mouse, and USB hardware. The communication port unit 790 may detect the connection of specific USB hardware and enable the specific USB hardware to function as the device 100 for generating super-resolution images.

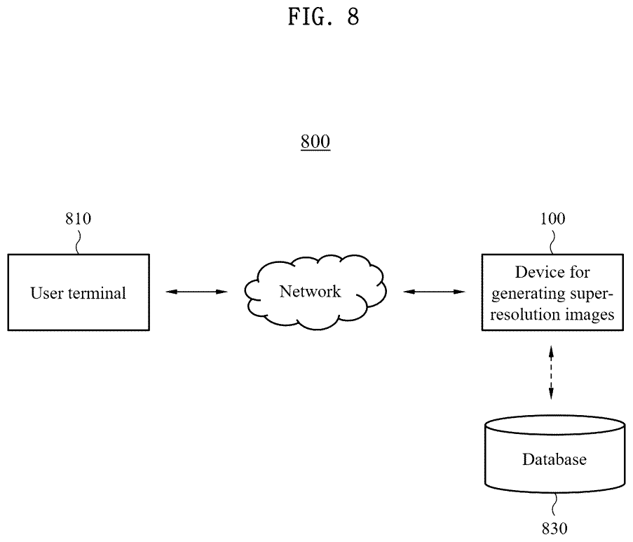

FIG. 8 illustrates a system for generating super-resolution images according to the present disclosure.

Referring to FIG. 8, the system 800 for generating super-resolution images may include a device 100 for generating super-resolution images and a database 830.

The user terminal 810 may correspond to a terminal device operated by a user. In the embodiment of the present disclosure, a user may be understood as one or more users, and a plurality of users may be grouped into one or more user groups. Also, the user terminal 810 may correspond to a computing device that operates in conjunction with the device 100 for generating super-resolution images, forming part of the system 800 for generating super-resolution images. For example, the user terminal 810 may be implemented as a smart phone, a high-definition TV, a laptop, or a computer operating by being connected to the device 100 for generating super-resolution images; however, the user terminal 810 is not necessarily limited to the specific examples and may also be implemented as various devices including tablet PCs. Also, the user terminal 810 may install and execute a dedicated program or application (or app) for interfacing with the device 100 for generating super-resolution images.

The device 100 for generating super-resolution images may be implemented as a server corresponding to a computer or a program that performs a method for generating super-resolution images through pixel level classification according to the present disclosure. Also, the device 100 for generating super-resolution images may be connected to the user terminal 810 through a wired network or a wireless network such as Bluetooth, WiFi, or LTE and may transmit and receive data to and from the user terminal 810 through the network.

Also, the device 100 for generating super-resolution images may be implemented to operate in connection with an independent external system (not shown in FIG. 8) to perform related operations. For example, the device 100 for generating super-resolution images may be implemented to provide various services in conjunction with a portal system, an SNS system, a cloud system, and others.

The database 830 may corresponding to a storage device storing various types of information required for the operation of the device 100 for generating super-resolution images. For example, the database 830 may store information related to images, training data, and models; however, the information is not necessarily limited to the specific types, and the database 830 may also store information in various forms collected or processed while the method for generating super-resolution images through pixel level classification according to the present disclosure is performed.

Also, FIG. 8 illustrates the database 830 as a separate device from the device 100 for generating super-resolution images; however, the present disclosure is not limited to the specific case, and it should be noted that the database 830 may also be integrated within the device 100 for generating super-resolution images as a logical storage device.

Although the present disclosure has been described with reference to preferred embodiments given above, it should be understood by those skilled in the art that various modifications and variations of the present disclosure may be made without departing from the technical principles and scope specified by the appended claims below.

[National Research Development Project supporting the Present Invention] [Project Serial No] 2710006677

[Project No] RS-2020-II201361

[Department] Ministry of Science and ICT

[Project management (Professional) Institute] Institute of Information & Communications Technology Planning & Evaluation

[Research Project Name] Nurturing ICT and Broadcasting Innovation Talents

[Research Task Name] Artificial Intelligence Graduate School Support Project (Yonsei University)

[Project Performing Institute] University Industry Foundation, Yonsei University

[Research period] 2024.01.01˜ 2024.12.31

[National Research Development Project supporting the Present Invention]

[Project Serial No] 1711182591

[Project No] 2022R1A2C2004509

[Department] Ministry of Science and ICT

[Project management (Professional) Institute] National Research Foundation of Korea

[Research Project Name] Mid-Career Researcher Program

[Research Task Name] Developing Online Temporal Action Localization Algorithm for Real-time Streaming Video Understanding

[Project Performing Institute] University Industry Foundation, Yonsei University

[Research Period] 2024.03.01˜2025.02.28

[Detailed Description of Main Elements]

| | |
|---|---|
| 100: Device for generating | |
| super-resolution images | |
| 110: Image input unit | 120: Backbone network unit |
| 130: Pixel classifier | 140: Upsampling unit |
| 140a, 140b: Upsampler | 150: Super-resolution |
| | image output unit |
| 800: System for generating | |
| super-resolution images | |

What is claimed is:

1. A device for generating super-resolution images through pixel level classification, the device comprising:
an image input unit receiving a low-resolution image;
a backbone network unit providing the low-resolution image to a backbone network as input data to generate a low-resolution feature map as output data;
a pixel classifier receiving the low-resolution feature map and coordinates of a specific pixel and determining an upsampler responsible for reconstruction by predicting reconstruction difficulty of the specific pixel;
an upsampling unit including a plurality of upsamplers constructed based on the reconstruction difficulty and performing a pixel level operation which upsamples the specific pixel through the determined upsampler responsible for the reconstruction among the plurality of upsamplers; and
a super-resolution image output unit generating a super-resolution image by outputting the upsampled specific pixel at the coordinates of the specific pixel of the low-resolution image.

2. The device of claim 1, wherein the backbone network unit selects the Fast Super-Resolution Convolutional Neural Network (FSRCNN), the Cascading Residual Network (CARN), or the Super-Resolution Residual Network (SRResNet) as the backbone network based on reconstruction characteristics of the low-resolution image.

3. The device of claim 1, wherein the pixel classifier determines one of reconstruction difficulty levels assigned for processing to the plurality of upsamplers based on the low-resolution feature map as the reconstruction difficulty of the specific pixel.

4. The device of claim 1, wherein the pixel classifier determines an upsampler with a relatively large capacity if the specific pixel is composed of a relatively complex pattern or texture.

5. The device of claim 4, wherein the pixel classifier determines an upsampler with a relatively small capacity if the specific pixel is composed of a relatively simple pattern.

6. The device of claim 1, wherein the upsampling unit determines the reconstruction difficulty level based on the low-resolution feature map and determines the number of the plurality of upsamplers.

7. The device of claim 1, wherein the upsampling unit implements the plurality of upsamplers to perform different upsampling techniques according to the reconstruction difficulty level.

8. The device of claim 1, wherein the super-resolution image output unit performs pixel-wise refinement on the super-resolution image to post-process artifact pixels if discontinuity occurs between adjacent pixels reconstructed through the plurality of upsamplers.

9. The device of claim 1, wherein the super-resolution image output unit determines the discontinuity by applying Peak Signal-to-Noise Ratio (PSNR), Structural Similarity Index (SSIM), or Floating Point Operations (FLOPs) to the super-resolution image.

10. In a method for generating super-resolution images through pixel level classification performed by a device for generating super-resolution images through pixel level classification, a method for generating super-resolution images through pixel level classification comprising:
receiving a low-resolution image;
providing the low-resolution image to a backbone network as input data to generate a low-resolution feature map as output data;
receiving the low-resolution feature map and coordinates of a specific pixel and determining an upsampler responsible for reconstruction by predicting reconstruction difficulty of the specific pixel;
including a plurality of upsamplers constructed based on the reconstruction difficulty and performing a pixel level operation which upsamples the specific pixel through the determined upsampler responsible for the reconstruction among the plurality of upsamplers; and
generating a super-resolution image by outputting the upsampled specific pixel at the coordinates of the specific pixel of the low-resolution image.
